(19) United States
(12) Patent Application Publication
(10) Pub. No.: US 2021/0317016 A1
(43) Pub. Date: Oct. 14, 2021

(54) METHODS AND APPARATUS FOR NUTRIENT AND WATER RECOVERY FROM WASTE STREAMS

(71) Applicant: Babak Rezania, North Vancouver (CA)

(72) Inventor: Babak Rezania, North Vancouver (CA)

(21) Appl. No.: 16/091,360

(22) PCT Filed: May 12, 2016
(86) PCT No.: PCT/IB2016/052716

§ 371 Date: Apr. 22, 2019

(51) Int. Cl. C02F 1/52; C02F 3/30; C02F 1/66; C02F 1/74

(52) U.S. Cl. CPC C02F 1/5254; C02F 3/307; C05F 7/00; C02F 1/74; C02F 1/66

(57) ABSTRACT

The present invention is directed to equipment, systems and methods for recovering nitrogen, potassium, phosphates and water from wastewater effluents. More particularly the invention discloses methods and equipments for treating waste streams to produce water that can be discharged to the environment and concentrated potassium ammonium struvite solid fertilizers.

### TECHNICAL FIELD OF THE INVENTION

The present invention relates generally to the field of nutrients and water recovery from wastewater effluents. More particularly the invention discloses methods and equipments for treating waste streams to produce water that can be discharged to the environment and concentrated ammonium, phosphate, and potassium solid fertilizers.

### BACKGROUND OF THE INVENTION

While the invention is useful for many applications, it is directed in particular to the treatment of effluent streams containing organic matter and nutrients (i.e. ammonium, phosphate, and potassium) to produce low nutrient water and solid fertilizers containing ammonium, phosphate, and potassium (NPK). There are several industries that can benefit from the disclosed invention including municipal wastewater treatment plants, landfills, industrial biogas plants, animal farming, and phosphate mining and fertilizer production industries which all produce nutrient rich wastewater streams.

In particular, the anaerobic digestion process biologically degrades organic wastes slurries to release biogas for electricity production while releasing the nutrients into the liquids. The anaerobic digestion includes engineered high efficiency and low efficiency anaerobic digestion. The high efficiency digestion includes mixed industrial and municipal digestion reactors and low efficiency digestion includes municipal landfills, open and closed manure lagoon, and high solid anaerobic digestion.

The effluent of all anaerobic digestion reactors comprises of high nutrient wastewater slurry, called “digestate” which is transported to the landfill or land applied. The disposal of digestate, similar to many other nutrient rich wastewaters, negatively affect soil and water quality due to biologically decomposable organics, pathogens, odours, and nutrients in particularly phosphorus and ammonia. When these pollutants reach bodies of water, either because they leached from disposal sites or as a result of being directly released or transported into water bodies, they consume the oxygen in the receiving waters and will cause eutrophication that may result in diminishing the receiving waters' capability to support aquatic life. Digestate often contains heavy metals that may limit and prevent its application to land.

The efficiency and cost effectiveness of organic waste management is considerably enhanced when, in addition to biogas production, digestate is processed on site to recover nutrients in the digestate as a valuable fertilizer and produce clean water that can be discharged to the environment. In addition, the nutrients tend to precipitate in the digester and digestate handling pipes creating operational and maintenance problems for many biogas facilities.

Digestate contains high concentration of soluble ammonium, potassium, phosphate, organic matter, and suspended solids. One approach to recover nutrients from liquid wastewaters such as digestate is through a chemical reaction to precipitate struvite. Struvite is a solid mineral chemically equivalent to magnesium ammonium phosphate hexa-hydrate, MgNH₄PO₄.6H₂O and is formed by reaction of magnesium, phosphate, and ammonium at elevated pH.

Mg⁺²+NH₄⁺+PO₄⁻³+6H₂O˜MgNH₄PO₄.6H₂O (Eq.1)

Struvite recovery is achieved in reactor vessels where wastewater containing nutrients (i.e ammonium, potassium, and phosphate) is mixed with an alkali source and magnesium containing solution to promote struvite precipitation. The struvite recovery for treatment of high nutrient wastewaters including digestate has several limitations.

Although several reactors have been reported in prior arts, they are not cost effective for digestate treatment, in particular, for smaller flow applications due to the followings:

The effluent of struvite recovery reactors contains high concentrations of potassium and leftover ammonium not suitable for discharge to water bodies or reuse. This is mainly due to the fact that there is a surplus of ammonium and limited amount can be captured in struvite crystals.

Another major problem of struvite reactors is associated with the formation of small struvite crystals (i.e. fines), particularly when treating high suspended solids waste streams, as it can be washed with the treated effluent which compromises final effluent quality due to their low sedimentation rate and the economic viability of the process effluent.

The product of struvite reactors disclosed in prior arts does not contain all the required elements for plant growth (i.e. NPK). Potassium is an important and valuable element found in wastewater/digestate and is not captured in the struvite reactor. There is a need for the potassium to be incorporated to the granular struvite for increased value and nutrient balance of struvite as a fertilizer.

The example of recirculating crystallizers/reactors used to remove and granulate phosphorus from waste solutions have been described in various references. Existing reactors are costly to build and operate. Small struvite particles retention requires large footprint and large reactor parts to retain the small particles. The quality of large struvite particles formed by small particles binding is also dependent on the level of organic suspended solids in the wastewater feed. Suspended solids in the wastewater fed to the struvite reactors after accumulating in large reactor areas are mixed in with the struvite particles producing low quality products. In addition, expensive materials are required to build the crystallizer as the crystallizer environment is very abrasive due to fluidization and contact of particles with the reactor.

References herein included by reference in their entirety are:
JPH08168776 A (SHIZUO, A et al.) Jul. 2, 1996, the whole document.
JPS60179190 A (IZUMI, H) Sep. 13, 1985, the whole document.
JPH04141293 A (NOBORU, F et al.) May 14, 1992, the whole document.
JP2000334473 A (SATOSHI, I et al.) Dec. 5, 2000, the whole document.
JPH09117774 A (TAKESHI, N et al.) May 6, 1997, the whole document.
JPH08337407 A (TAKESHI, N et al.) Dec. 24, 1996, the whole document.
JPH11267665 A (MASAO, T et al.) Oct. 5, 1999, the whole document
U.S. Pat. No. 8,017,019 B2 (BECKER, G Y et al.) Sep. 13, 2011, the whole document.
U.S. Pat. No. 7,622,047 B2 (Koch, F A et al.) Nov. 24, 2009, the whole document.
U.S. Pat. No. 7,005,072 B2 (BOWERS, K E et al.) Feb. 28, 2006, the whole document.

In order to address the limitations described above, one object of present invention is to provide methods for simultaneously removing ammonium, phosphate, and potassium as solid fertilizers from nutrient rich waste streams, and produce low nutrient dischargeable water.

A second object of present invention is to provide small footprint struvite reactors with enhanced particle retention, and ammonium and potassium removal for producing struvite granules containing ammonium, potassium, and phosphate (NPK), and low nutrient water.

### SUMMARY OF INVENTION

The present invention addresses the problems outlined above and provides improved nutrient recovery apparatus and methods particularly suited for the treatment of waste streams containing suspended solids, nitrogen, phosphorus, and potassium elements such as landfill leachate, digestate slurries or liquor, and urine.

According to the first aspect of the present invention, a method for removal of ammonium, potassium, and phosphate from wastewater streams without additional external alkaline source and addition of phosphoric acid is disclosed.

The method comprises of adding phosphoric acid to the wastewater containing ammonium, potassium, and phosphate to co-precipitate ammonium and potassium struvite without addition of external alkaline source to the wastewater.

The disclosed method comprises adding external phosphoric acid to the wastewater having total alkalinity of A and initial concentrations of ammonium (N), phosphate (P), and potassium (K) to increase the phosphate concentration to P2 so that A/P2 mass ratio exceeds 4. Adding air to the wastewater to remove dissolved carbon dioxide and increase the pH. Then adding external magnesium salt (Mg) to the wastewater at Mg/P2 molar ratio of 0.8-1.2.

Mixing and/or aerating the said wastewater to remove residual dissolved CO2, reaching pH of at least 7 which results in formation of ammonium potassium struvite (NH₄KMgPO₄*6H₂O) and alkalinity removal during struvite formation. Lastly, separating precipitated solids from the liquid produces ammonium potassium struvite and low nutrient water.

The method described above eliminates the need for alkali source addition for struvite formation and enhances nutrient captured from wastewater resulting in low nutrient water and struvite. The method can be applied to both liquid wastes and slurries such as digestate before dewatering. According to one of the aspects in the above described method, the nutrients are precipitated in the sludge and then separated to produce biosolids with high NPK value and low nutrient water.

The second aspect of the present invention discloses another method for removal of ammonium, potassium, and phosphate from wastewater. This method improves the method described in the first aspect of the invention to maximize NPK removal from wastewater, particularly from wastewater having low initial alkalinity through the combination of struvite formation and ammonia stripping.

The method comprises of simultaneous removal of NPK from wastewater by adding external alkalinity, phosphoric acid (P), and magnesium (Mg) to the wastewater containing initial concentrations of ammonium (N1), phosphate (P1), and potassium (K1).

The method comprises of adding phosphoric acid to wastewater first to increase the phosphate concentration of the said wastewater to P2 wherein P2/K molar ratio<5.5.

Then adding and mixing alkalinity to the said wastewater to increase the pH and alkalinity.

Adding magnesium chloride solution at Mg/P2 molar ratio of 0.8-1.2; mixing and/or aerating the said wastewater to simultaneously remove dissolved CO2 and ammonia, which results in formation of ammonium potassium struvite (NH₄KMgPO₄.6H₂O) and alkalinity removal during struvite formation. Separating precipitated solids containing NPK from liquid produces low nutrient water and ammonium potassium struvite.

The methods described above can be applied to the waste slurries, particularly digestate and manure, to produce low nutrient water and organic biosolids fertilizer containing high concentrations of NPK. The other preferred application of the described method is for treatment of liquid wastewater such as landfill leachate, digestate liquor to produce NPK fertilizer and low nutrient water.

The third aspect of the present invention discloses a process for treating nutrient slurries such as digestate or manure to produce low nutrient water and high NPK biosolids. The process comprises of transferring the waste slurries to a precipitation tank equipped with an inflow pipe for transferring the waste slurries into the tank, mixing device, an aeration device for injecting air into the precipitation tank, an outflow pipe connected to a solids separation deceive for transferring the content of the tank to the solids separation device. The solids separation device separates the waste slurry into water and concentrated solids, and exits the solids separation device via two separate discharge ports. The wastewater is mixed and aerated with phosphoric acid and magnesium source according to the methods described above to precipitate phosphates, ammonium, and potassium in the liquid portion of the waste slurry. The precipitated nutrients mixed with the organic solids in the precipitation tank, and captured and removed by the solids separation device, combined to produce high NPK solids and water with low nutrient content that can be discharged or reused. The described system can be incorporated as part of the conventional solids separation systems such as dissolved air flotation, centrifuge, screw press, or rotary press systems where the sludge premixing tank is retrofitted to add magnesium and phosphoric acid ports.

According to the forth aspect of the present invention, fluidized bed reactor and granulator are provided to granulate the nutrients according to the methods described in the first and second aspects of the present invention. The upflow fluidized bed reactor comprises of an elongated lower tubular section connected to an elongated upper section with a relative diameter of upper section to lower section between 1.378 and 1.598, and most preferably about 1.516 wherein the particles inside the reactor are fluidized by the recycle flow from the upper section to the lower section.

The lower section has two inflow and one outflow ports. The upper settling section is equipped with two flow outlets. The upper flow outlet (effluent) is for transferring the treated wastewater out of the fluidized bed reactor and the lower flow outlet is for recycling the flow from the upper setting section to the lower section via a recycle pump to provide fluidization. The lower flow outlet in the upper section of the reactor has two functions: recycling the flow to the lower section and reducing the flow velocity in the area between the upper outlet and lower outlet. The low velocity in the section above the recycle line allows for settling and capturing small particles that is transferred to the lower section. The biological suspended solids, mostly accumulated in the area above the recycle line, are transferred to the reactor effluent. The outflow recycle outlet can be provided in the side wall of the settling section or a pipe can be inserted into the settling section to withdraw and recycle the liquid to the lower section. The outflow recycle outlet withdraws the liquid mixed with fine particles via a pipe with a funnel at the end. The distance between recycle flow outlet and upper flow outlet is selected to have a minimum of 1.5 meter to provide settling zone for the fine particles.

The fluidized bed reactor is connected to a feeding system comprised of a feed tank wherein the wastewater is mixed with phosphoric acid and air before transferring to the lower section of the fluidized bed reactor via a feed pump.

The treated wastewater exits the reactor from the upper section of the reactor via an outflow port to an external reactor. The external reactor is comprised of a reactor vessel and a clarifier at the end of the said reactor vessel, an overflow port for allowing the content from the reactor vessel to flow to the clarifier, an air pump for mixing the content of the reactor vessel and stripping ammonia from the wastewater, an outflow liquid effluent port on the upper part of the clarifier, an outflow port in the lower section of the clarifier that transfers the content of the clarifier to the fluidized bed reactor via a pump.

The feed wastewater flow, recycle flow, and magnesium flow are mixed in the lower section of the fluidized bed reactor with magnesium at Mg/P molar ratio of at least 0.8 and seed material that are added to the lower section of the reactor from the external tank. The recycle flow is used as the initial fluidization of seed material. Feed and Mg solution are added to the reactor proportionally which results in precipitation of struvite on the seed material forming granular struvite. The large particles accumulate in the lower section of the reactor are removed periodically via an outflow valve.

In another aspect of the invention, the fluidized bed system is operated for co-precipitation of ammonium potassium struvite (NH₄KMgPO₄.6H₂O). Despite what is perceived in the literature that potassium struvite can be precipitated by reacting magnesium, potassium, and phosphate ions under the absence of ammonium, the author found the reaction Mg, P, and K reaction at elevated pHs often results in precipitation of magnesium phosphate without significant potassium uptake. The co-precipitation of ammonium and potassium struvite takes place at preferred ammonium, potassium, phosphate, and magnesium molar ratios discussed in the first and second aspects of the present invention

The disclosed method comprises of adding external phosphoric acid to the wastewater in the feed tank having total alkalinity of A and initial concentrations of ammonium (N), phosphate (P), and potassium (K) to increase the phosphate concentration to P2 so that A/P2 mass ratio exceeds 4. Adding air to the said wastewater in the feed tank to remove dissolved carbon dioxide and increasing the pH. Transferring the feed to the lower section of the fluidized bed reactor where the wastewater is mixed with external magnesium salt solution (Mg), particularly magnesium chloride, at Mg/P2 molar ratio of 0.8-1.2.

Treating the said wastewater in the fluidized bed reactor to remove residual dissolved CO2, reaching pH of at least 7, which results in formation of ammonium potassium struvite (NH₄KMgPO₄.6H₂O) and alkalinity removal during struvite formation; then, separating precipitated solids containing NPK from liquid in the upper section of the fluidized bed reactor followed by further polishing of treated wastewater in the external reactor vessel to capture residual suspended solids.

In another aspect of the invention, the external tank is operated as a biological reactor for treatment of fluidized bed reactor effluent. This is achieved by turning off the multifunctional tank recycle pump and directing all or a portion of the fluidized bed reactor effluent to the tank via effluent valve. Nitrifying bacteria or combination of anammox and nitrifying bacteria are initially added to the multifunctional tank. The dissolved oxygen is kept below 2 mg/L. The ammonium and organic matters in the fluidized bed effluent are oxidized to nitrate and nitrite to produce low nitrogen effluent.

In another aspect of the invention, a process for granulating ammonium, phosphate, and potassium in wastewater and producing low NPK dischargeable water is disclosed. The process comprises of adding phosphoric acid to wastewater having total alkalinity of A and initial concentrations of ammonium (N), phosphate (P), and potassium (K) to increase the phosphate concentration of the said wastewater to P2 wherein P2/K molar ratio<5.5.

Then adding and mixing alkalinity to the said wastewater in the feed tank to increase the pH to 9-11. Transferring the feed to the lower section of the fluidized bed reactor where the wastewater is mixed with external magnesium salt solution (Mg), particularly MgCl₂, at Mg/P2 molar ratio of 0.8-1.2.

Treating the said wastewater in the fluidized bed reactor to remove residual dissolved CO2 and strip ammonia, maintaining pH of 9-11, which results in formation of ammonium and potassium struvite NH₄KMgPO₄.6H₂O and alkalinity removal during struvite formation; then, separating precipitated solids containing NPK from liquid in the upper section of the fluidized bed reactor followed by further polishing of treated wastewater in the external reactor. Aerating the wastewater in the external reactor to strip residual ammonia and capture residual suspended solids in the clarifier section of the external reactor.

### BRIEF DESCRIPTION OF DRAWINGS

The present invention is described in conjunction with reference to the following drawings which illustrate embodiments of the invention, but which should not be construed as restricting the spirit or scope of the invention in any way.

FIG. 1 is a schematic of an up flow reactor apparatus for phosphorus, nitrogen and potassium recovery from wastewater.

FIG. 2 is a schematic of a waste slurry treatment process to produce low nutrient water and organic biosolids fertilizer.

### DETAILED DESCRIPTION OF EMBODIMENTS

According to a first preferred aspect of the present invention, there is provided an upflow fluidized bed reactor apparatus for phosphorus, nitrogen, and potassium recovery from wastewater.

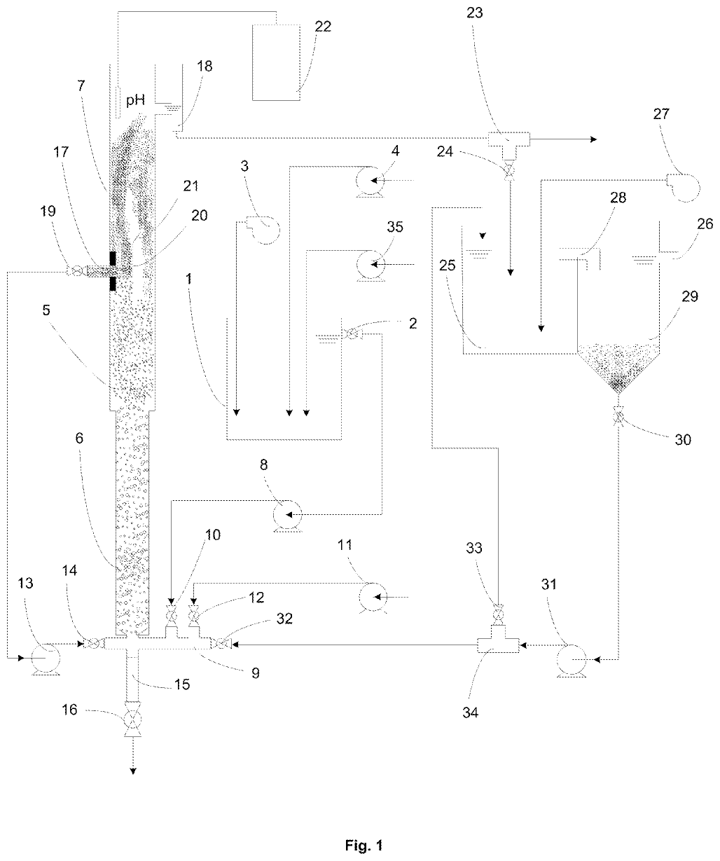

In reference to FIG. 1, a schematic of nutrient recovery system is shown comprising a feed tank (1) for feed preparation, fluidized reactor vessel (5) for the precipitation and granulation of nutrients including phosphate, ammonium and potassium in wastewater, and a multifunctional external tank (25) for polishing the wastewater effluent from the fluidized reactor vessel.

The feed tank (1) is equipped with a valve (2), an air pump (3) for removing dissolved carbon dioxide and increasing pH of the untreated wastewater, an alkalinity pump (35) for adding external alkalinity source to the untreated wastewater to increase the alkalinity, and a chemical dosing pump (4) for adding the phosphoric acid to the untreated wastewater for increasing the phosphate concentration.

The fluidized reactor vessel (5) is comprised of a tubular lower section (6) having a diameter of d1 and a larger upper section (7) configured as tube or cone connected to the lower section (6) having a most upper section diameter of d2 where the d2/d1 is preferebly 1.516. The lower section (6) is equipped with a liquid inflow pump (8) connected to an inflow pipe (9) and valve (10) for transferring the untreated wastewater into the lower section (6), a chemical feed pump (11) connected to an inflow pipe (9) and valve (12) for injecting a magnesium solution into the lower section (6) of the reactor (5); a recycle pump (13) connected to an inflow pipe (9) and valve (14) for recycling the content of the upper section (7) to the lower section (6); an outflow pipe (15) and a sample valve (16) for withdrawing agglomerated phosphate containing crystals out of the lower section (6).

The upper section of the reactor (7) is comprised of an outflow recycle port (17) and an outflow effluent port (18) for transferring the treated wastewater out of the reactor (5). The vertical distance between outflow effluent port (18) and outflow recycle port (17) in the upper section (7) is at least 1.5 meters, but preferably 3-4, m to provide adequate retention time to the section above the recycle line. The outflow recycle port (17) is connected to a valve (19) on the outside of the upper section (7) and a recycle inflow pipe (20) with a funnel (21) at its end, located inside the upper section (7), for collecting the liquid and fine particles in the reactor's upper section (7). The untreated wastewater, magnesium solution and recycle flow are mixed in the lower section (6) of the reactor vessel (5) where precipitation of struvite occurs. The upper section (7) is equipped with a pH monitoring device (22). The outflow effluent port (18) is connected to a flow splitting device (23) and a valve (24) for directing a proration of effluent flow to the multifunctional external tank (25). The multifunctional external tank (25) may be operated as a seed injection tank, a biological reactor for removing organics and left over nutrients from the effluent of the fluidized reactor (5) The multifunctional external tank (25) is equipped with an effluent pipe (26) an air pump (27) for injecting air into the tank (25), an overflow pipe (28) for transferring the tank content to the clarifier section (29), recycle outflow port (30), and a pump (31) connected to a flow splitting device (34) and a valve (33) for directing a proration of flow to the inflow pipe (9) and valve (32) that transfers the content of the clarifier (29) to the lower section (6) and/or back to the multifunctional external tank (25).

According to a second preferred aspect of the present invention, there is provided a method for co-precipitation and granulation of ammonium and potassium struvite (NH4KMgPO4.6H₂O) described in the first aspect of the invention in reference to FIG. 1.

The method comprises of pumping a seed material via a multifunctional external tank (25) to the lower section (6) of the fluidized bed reactor (5) wherein the seed material is fluidized by a recycle pump (13). Mixing of the untreated wastewater with phosphoric acid via a chemical dosing pump (4) to the wastewater having total alkalinity of A and initial concentrations of ammonium (N), phosphate (P), and potassium (K) to increase the phosphate concentration to P2 so that A/P2 mass ratio exceeds 4. Adding air to the solution to remove dissolved carbon dioxide and increasing the pH in the feed tank (1). Pumping the wastewater to the lower section (6) of the reactor (5), injecting magnesium solution to the lower section (6) of the said reactor (5), and adjusting the concentration of Mg so that the molar ratio of the wastewater nutrients has a Mg/P2 0.8.-1.2. This will result in precipitation of NH₄KMgPO₄.6H₂O in the fluidized bed reactor (5) and production of reactor effluent. The reactor effluent is transferred to a multifunctional external tank (25) wherein the said reactor effluent is aerated by air pump (27) to strip out carbon dioxide and dissolved ammonia gas. The content of the multifunctional external tank (25) is transfer to the clarifier section (29) via an overflow pipe (28) wherein the fine struvite particles are captured and transferred to the lower section (6) of the fluidized bed reactor (5) wherein they are granulated to large particles having at least 1 mm in diameter.

According to other aspects of the present invention, the multifunctional external tank (25) is used as a biological reactor to remove more ammonia from the wastewater. This is achieved by turning off the pump (31), adding a mixture of anammox bacteria and nitrifying bacteria seed to the multifunctional external tank (25), and turning on the air pump (27). Aeration in the multifunctional external tank (25) provides the condition of biological ammonium removal by anammox bacteria wherein the dissolved oxygen concentration is kept below 2 mg/L.

According to a third preferred aspect of the present invention, there is provided a process for co-precipitation and granulation of ammonium and potassium struvite (NH₄KMgPO₄.6H₂O) and production of dischargeable water described in the first aspect of the invention in reference to FIG. 1.

The process comprises of adding phosphoric acid via chemical dosing pump (4) to wastewater stored in the feed tank (1) having total alkalinity of A and initial concentrations of ammonium (N), phosphate (P), and potassium (K) to increase the phosphate concentration of the said wastewater to P2 wherein P2/K molar ratio<5.5.

Then, adding and mixing alkalinity via an alkalinity pump (35) to the said wastewater in the feed tank (1) to increase the pH to 9-11. Transferring the feed to the lower section (6) of the fluidized bed reactor (5) where the wastewater is mixed with external magnesium salt solution (Mg), particularly MgCl₂, at Mg/P2 molar ratio of 0.8-1.2.

Treating the said wastewater in the fluidized bed reactor (5) to remove residual dissolved CO2 and strip ammonia, maintaining pH at 9-11, which results in formation of ammonium and potassium struvite (NH₄KMgPO₄.6H₂O) and alkalinity removal during struvite formation; then, separating precipitated solids containing NPK from liquid in the upper section (7) of the fluidized bed reactor (5) followed by further polishing the treated wastewater in the multifunctional external tank (25). The content of the multifunctional tank (25) is transferred to the clarifier section (29) via an overflow pipe (28) wherein the fine struvite particles are captured and transferred to the lower section (6) of the fluidized bed reactor (5) wherein they are granulated to large particles.

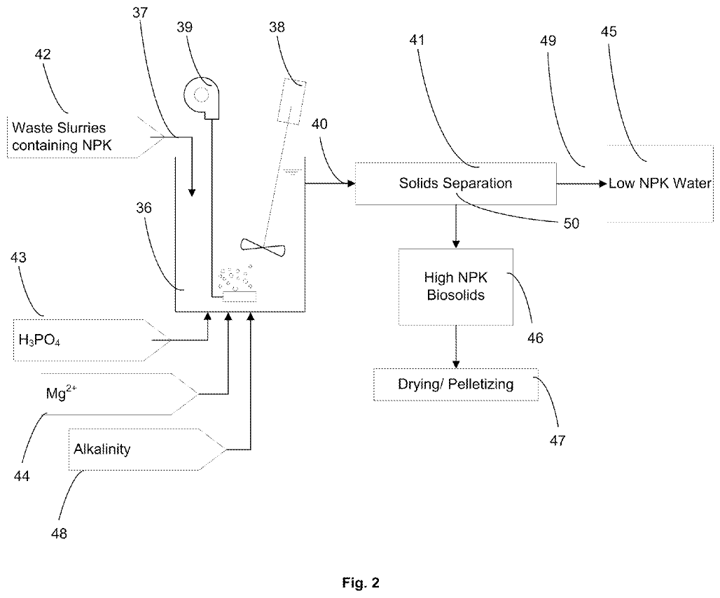

In reference to FIG. 2, a schematic of a waste slurry treatment process to produce low nutrient water and organic biosolids fertilizer is provided.

The process comprises of transferring the waste slurries (42) to a precipitation tank (36) that is equipped with an inflow pipe (37) for transferring the waste slurries into the tank (36), mixing device (38), an aeration device (39) for injecting air into the precipitation tank (36), an outflow pipe (40) connected to a solids separation device (41) for transferring the content of the tank (36) to the solids separation device (41). The solids separation device (41) separates the waste slurries into low NPK water and high NPK biosolids that exit the solids separation device (41) via two separate discharge ports: solids discharge port (50) and liquid discharge port (49).

The waste slurries having total alkalinity of A and initial concentrations of ammonium (N), phosphate (P), and potassium (K) is mixed with phosphoric acid (43) to increase the phosphate concentration to P2 so that A/P2 mass ratio exceeds 4. Adding air via aeration device (39) to the mixture in the precipitation tank (36) to remove dissolved carbon dioxide and increase the pH.

Adding external magnesium (Mg) salt (44) to the precipitation tank at Mg/P2 molar ratio of 0.8-1.2.

Mixing and/or aerating the said waste slurries to remove residual dissolved CO2, reaching pH of at least 7 which results in the formation of ammonium and potassium struvite (NH₄KMgPO₄.6H₂O) and alkalinity removal during struvite formation. Separating solids from the liquid using a solids separation device (41) separates the waste slurries into low NPK water (45) and high NPK biosolids (46). The high NPK biosolids (46) are further dried and pelletized (47). The described system can be incorporated as part of the conventional solids separation systems such as dissolved air flotation, centrifuge, screw press, or rotary press systems where the sludge premixing tank is retrofitted to add magnesium and phosphoric acid ports.

In another aspect of the waste slurry treatment process, the NPK removal from the slurry is maximized through simultaneous struvite formation and ammonia stripping. The method comprises of simultaneously removing NPK from waste slurry by adding external alkalinity, phosphoric acid (P2), and magnesium (Mg) to the waste slurry containing initial concentrations of ammonium (N1), phosphate (P1), and potassium (K1). The method comprises of adding phosphoric acid to waste slurry first to increase the phosphate concentration of the said waste slurry to P2 wherein P2/K molar ratio<5.5.

Then adding and mixing alkalinity (48) to the said waste slurry to increase the pH and alkalinity. Adding magnesium chloride (Mg) solution at Mg/P2 molar ratio of 0.8-1.2; mixing and/or aerating the said waste slurry to simultaneously remove dissolved CO2 and ammonia, which results in formation of ammonium and potassium struvite (NH₄KMgPO₄.6H₂O) and alkalinity removal during struvite formation. Separating precipitated solids containing NPK from the liquid using a solids separation device (41) produces low NPK water (45) and high NPK biosolids (46). The described system can be incorporated as part of the conventional solids separation systems such as dissolved air flotation, centrifuge, screw press, or rotary press systems where the sludge premixing tank is retrofitted to add magnesium, phosphoric acid, and alkalinity ports.

### Example 1

A method for removal of ammonium, potassium, and phosphate from wastewater streams without additional external alkaline source and addition of phosphoric acid is described in the following example.

25 mL of food waste digestate with initial ammonium, phosphate, potassium (K), and alkalinity (A1) concentrations of 2260 ppm N, 39 ppm P, 1208 ppm K, and 12500 ppm CaCO3 respectively was spiked with phosphoric acid (75% concentration) to increase the phosphate (P2) concentration to 3110 ppm P so that the P2/K molar ratio becomes 2.97 and the A1/P2 mass ratio exceeds 4. Then, air was added to the wastewater for 60 minutes to remove dissolved carbon dioxide and increase the pH from 7.91 to 8/1. After, magnesium chloride (Mg) was added to the solution at Mg/P2 molar ratio of 0.8. The solution was mixed and aerated to remove residual CO2 and maintain the pH of at least 7 for 10 min which resulted in the formation of ammonium potassium struvite (NH₄KMgPO₄.6H₂O). Struvite was separated from the treated food waste digestate using a centrifuge; the food waste digestate had a final ammonium, phosphate, and potassium concentrations of 1122 ppm N, 61 ppm P, and 1127 ppm K respectively. The ammonium, phosphate, and potassium removal rates were determined to be 50%, 98%, and 14% respectively.

| | Initial Sample | Final Sample | Removal Rates |
|---|---|---|---|
| | (ppm) | (ppm) | (%) |
| Ammonium | 2260 | 1122 | 50 |
| Phosphate | 39 | 61 | 98 |
| Potassium | 1316 | 1127 | 14 |
| Alkalinity | 12500 | 875 | 93 |

### Example 2

An improved method for removal of ammonium, potassium, and phosphate from wastewater streams with addition of phosphoric acid and external alkaline source is described in the following example.

50 mL of food waste digestate with initial ammonium, phosphate, and potassium (K) concentrations of 1030 ppm N, 250 ppm P, and 1472 ppm K respectively was spiked with phosphoric acid (75% concentration) to increase the phosphate (P2) concentration to 5865 ppm P so that the P2/K molar ratio becomes 5.01. Then, the food waste digestate was mixed with 5N sodium hydroxide (external alkalinity source) so that the alkalinity increased from 4500 ppm CaCO3 to 14089 ppm CaCO3 and the pH increased from 8.13 to 11.56. After, magnesium chloride (Mg) was added to the solution at Mg/P2 molar ratio of 0.8. The solution was mixed and aerated to remove residual CO2 and maintain the pH of at least 11 for 30 min which resulted in the formation of ammonium potassium struvite (NH₄KMgPO₄.6H₂O) and simultaneously stripping the residual ammonia. Struvite was separated from the treated food waste digestate using a centrifuge; the food waste digestate had a final ammonium, phosphate, and potassium concentrations of 151 ppm N, 70 ppm P, and Oppm K respectively. The ammonium, phosphate, and potassium removal rates were determined to be 85%, 99%, and 100% respectively.

| | Initial Sample | Final Sample | Removal Rates |
|---|---|---|---|
| | (ppm) | (ppm) | (%) |
| Ammonium | 1030 | 151 | 85 |
| Phosphate | 250 | 70 | 99 |
| Potassium | 1472 | 0 | 100 |

### Example 3

A method for removal and granulation of ammonium and phosphate from wastewater streams without additional external alkaline source and phosphoric acid in the fluidized bed reactor is described in the following example.

Struvite seeds were initially seeded to the fluidized bed reactor (FIG. 1) by pumping the seed material via the multifunctional external tank to the lower section of the fluidized bed reactor via the pump. Municipal centrate was fed to the lower section of the fluidized bed reactor via the liquid inflow pump with initial ammonium and phosphate (P) concentrations of 838 ppm N and 144 ppm P respectively at a rate of 300 mL/min. The solution in the upper section was recycled back to the lower section via a recycle pump that was set at a minimum of 2000 mL/min to provide fluidization. 0.5M magnesium chloride (Mg) was added to the lower section of the fluidized bed reactor at a rate of 3.4 mLlmin so that the Mg/P molar ratio was 1.2. Then, struvite granulated to large particles over 100 hours and was separated from the treated municipal centrate through the sample valve at the bottom of the lower section; the treated municipal centrate exited the fluidized bed reactor through the outflow effluent port located in the upper section of the reactor and had a final ammonium and phosphate concentrations of 749 ppm N and Oppm P respectively. The ammonium and phosphate removal rates were determined to be 11% and 100% respectively.

| | Initial Sample | Final Sample | Removal Rates |
|---|---|---|---|
| | (ppm) | (ppm) | (%) |
| Ammonium | 838 | 749 | 11 |
| Phosphate | 144 | 0 | 100 |

### Example 4

A method for removal and granulation of ammonium, phosphate, and potassium from wastewater streams with additional external alkaline source and phosphoric acid in the fluidized bed reactor is described in the following example.

Struvite seeds were initially seeded to the fluidized bed reactor (FIG. 1) by pumping the seed material via the multifunctional external tank to the lower section of the fluidized bed reactor via the pump. 280 mL of phosphoric acid (75% concentration) and was added to 200 L of digestate stored in the feed tank having total alkalinity of 4500 mg/L CaCO3 and initial ammonium, phosphate, and potassium (K) concentrations of 619 ppm N. 144 ppm P, and 1520 ppm K to increase phosphate (P2) concentration of the municipal centrate to 777 ppm P wherein P2/K molar ratio is 0.64. Then, 880 g of sodium hydroxide was added to the 200 L of the said solution to increase the pH to 9.85. The said municipal centrate was fed to the lower section of the fluidized bed reactor via the liquid inflow pump at a rate of 31 mL/min. 0.5M magnesium chloride (Mg) was added to the lower section of the fluidized bed reactor at a rate of 1.8 mL/min so that the Mg/P2 molar ratio was 1.2. Then, struvite granulated to large particles over 24 hours and was separated from the liquid through the sample valve at the bottom of the lower section. The liquid exited the fluidized bed reactor through the outflow effluent port located in the upper section of the reactor into the multifunctional external tank where the fine struvite particles were captured in the clarifier section and were recycled back to the lower section via the pump that was set at a minimum of 1800 mL/min to provide fluidization. The treated municipal centrate exited the multifunctional external tank via the effluent pipe and had a final ammonium, phosphate, and potassium concentrations of 60 ppm N, Oppm P, and 992 ppm K respectively. The ammonium, phosphate, and potassium removal rates were determined to be 87%, 100%, and 35% respectively.

| | Initial Sample | Final Sample | Removal Rates |
|---|---|---|---|
| | (ppm) | (ppm) | (%) |
| Ammonium | 619 | 60 | 87 |
| Phosphate | 144 | 0 | 100 |
| Potassium | 0 | 992 | 35 |

We claim:

1. A method for recovering nitrogen, phosphorus, and potassium from wastewater and producing low nutrient water comprising: adding external phosphoric acid to the wastewater A having total alkalinity of (AL1) and initial concentrations of ammonium (N), phosphate (P), and potassium (K) to increase the phosphate concentration to (P2) at AL1/P2 mass ratio exceeding 4; adding air to the wastewater to remove dissolved carbon dioxide and increase the pH to the extent that pH stays constant; adding external magnesium salt to the wastewater at Mg/P2 molar ratio of 0.8-1.2; mixing and/or aerating the said wastewater to remove residual dissolved CO2, reaching pH of at least 7 which results in formation of ammonium potassium struvite (NH₄KMgPO₄.6H₂O), then separating precipitated solids containing NPK from liquid to produce low nutrient water and high NPK solids.

2. A method according to claim 1 wherein no external alkali source is used for struvite formation.

3. A method for recovering nitrogen, phosphorus, and potassium from wastewater by combined ammonia stripping and struvite formation comprising addition of phosphoric acid to wastewater (A) containing initial concentrations of ammonium (N1), phosphate (P1), and potassium (K1) to increase the phosphate concentration of the said wastewater to P2 wherein P2/K1 molar ratio<5.5; then adding and mixing external alkalinity source to the said wastewater to increase the pH and; adding magnesium chloride solution at Mg/P2 ratio of 0.8-1.2; mixing and/or aerating the said wastewater to simultaneously remove dissolved CO2 and ammonia, and formation of ammonium potassium struvite (NH₄KMgPO₄.6H₂O); continuing the aeration until ammonia concentration remains constant; separating solids from liquid to produce water containing low concentrations of nitrogen, phosphorus and potassium (low NPK water) and high NPK solids.

4. A method according to claim 3 wherein external alkalinity source is sodium carbonate or sodium hydroxide.

5. A method according to claim 3 wherein pH is kept between 9 to 11.

6. A process for producing low nutrient water and biosolids containing high concentrations of nitrogen, potassium, and phosphorus according to claims 1 to 5 wherein the said wastewater (A) is a digestate slurry and high NPK solids are mixture of organics and ammonium potassium struvite.

7. A process for precipitation and granulation of nutrients in wastewater (A) containing ammonium, phosphate, potassium, and alkalinity comprising: continuously transferring and mixing of the said wastewater with magnesium containing solution in a fluidized bed reactor having an elongated lower tubular section connected to an elongated upper tubular section with a relative diameter of upper section to lower section between 1.378 and 1.598, and most preferably about 1.516, wherein mixing and precipitating nutrients take place in the lower section of the reactor and precipitates are fluidized by a recycle flow from a recycle port from the upper section to the lower section; and the effluent wastewater (B) exits the upper section of the reactor from an effluent port in the upper tubular section of the reactor.

8. A process according to claim 7 wherein the total height of the said fluidized bed reactor is at least 3 meters and the distance between the said recycle port and effluent port is at least 1.5 meters.

9. A process according to claim 7 wherein fine precipitated particles accumulate in the said elongated upper tubular section between the said recycle port and effluent port; recycle back to the lower section of the fluidized bed reactor via a first recycle pump.

10. A process according to claims 7, 8 and 9 wherein the said fine precipitated particles recycle back to the lower section of the fluidized bed reactor via a recycle pump to grow in size and accumulate in the lower section of the reactor for harvesting.

11. A process according to claim 7 wherein the said effluent wastewater (B) is further aerated in a multifunctional reactor vessel coupled to an external clarifier wherein ammonia and carbon dioxide are stripped out of the effluent wastewater (B) to produce wastewater effluent (C) and fine particles are settled in the external clarifier.

12. A process according to claims 11 and 7 wherein the stetted particles in the external clarifier are pumped back to the lower tubular section of the said fluidized bed reactor via a second recycle pump.

13. A process according to claim 11 wherein the minimum hydraulic retention time of aerated reactor vessel is six hours.

14. A process according to claim 7 wherein magnesium solution is added to the reactor at minimum magnesium to phosphate molar ratio of 0.8.

15. A process according to claim 7 wherein the pH of wastewater in the upper section of the reactor is at least 6.9.

16. A process according to claim 11 wherein the multifunctional reactor vessel is converted to a biological reactor by adding mixture of Anammox bacteria and nitrifying bacteria to the said reactor and controlling the dissolved oxygen in the reactor below 2 mg/L and the content of said external clarifier is recycled back to the multifunctional tank via a pump.

17. A process according to claim 16 wherein the residual ammonium in the wastewater effluent is removed in the said multifunctional tank by the Anammox and nitrifying bacteria.

18. A process for precipitation and granulation of nutrients from wastewater and producing low nutrient water according to process of claims 7 to 17 and the method of claim 1 wherein the said wastewater A having initial alkalinity of AL1 is mixed with phosphoric acid in a feed tank to increase the phosphate concentration of said wastewater to (P2) so that AL1/P2 mass ratio exceeds 4 before transferring that wastewater to the said fluidized bed reactor to be mixed with a magnesium chloride solution to co-precipitate ammonium and potassium struvite.

19. A process for precipitation and granulation of nutrients from wastewater and producing low nutrient water according to process of claim 7 to 17 and the method of claim 3 wherein wastewater A is mixed with external phosphoric acid and alkaline solution in a feed tank to increase the phosphate concentration of the said wastewater to P2 wherein P2/K1 molar ratio<5.5; transferring and mixing the said wastewater with magnesium containing solution in the lower section of said fluidized bed reactor to precipitate to co-precipitate ammonium and potassium struvite.

20. A process according to claims 18, 19 wherein magnesium chloride solution is added to the lower section of the fluidized bed reactor at Mg²⁺ to P2 molar ratio of 0.8 to 1.2.

21. A process according to claim 19 wherein alkaline solution is added to the said wastewater A in the feed tank to increase the pH to 9-11.

22. A process according to claims 18 19 and 11 wherein the effluent wastewater (C) is a dischargeable water with low concentrations of ammonium, phosphate and potassium.
